(19) United States
(12) Patent Application Publication
(10) Pub. No.: US 2011/0231328 A1
(43) Pub. Date: Sep. 22, 2011

(54) Methods And Systems For Shareholder Information Sharing And Collaboration

(76) Inventor: Argus I. Cunningham, Naples (IT)

(21) Appl. No.: 13/050,428

(22) Filed: Mar. 17, 2011

Related U.S. Application Data
(63) Continuation-in-part of application No. 13/019,038, filed on Feb. 1, 2011.
(60) Provisional application No. 61/315,293, filed on Mar. 18, 2010.

(51) Int. Cl. G06Q 99/00

(52) U.S. Cl. 705/319

(57) ABSTRACT

Methods and systems for a server-based internet accessible efficient exchange of shareholder information between mutual shareholders, shareholder representatives, concerned parties, and the concerned corporations utilizing a database and software for automatic execution of the methods. The database contains, for example, individual account data of registered shareholders, a data base of known corporate contact information. Software applications provide, for example, an email generating application, a date/time keeping application, an evaluation and outcome application that displays process information, an electronic notification process, a database recording function that records the correspondence, and a search function that allows concerned members to access the historical data.

### CROSS REFERENCE TO RELATED APPLICATIONS

This application relates to co-pending U.S. provisional patent application Ser. No. 61/315,293 filed Mar. 18, 2010 and entitled “Process for Stock Shareholder Information Sharing and Collaboration,” and is a continuation-in-part of, claims priority from and the benefit of co-pending U.S. utility application Ser. No. 13/019,038, filed Feb. 1, 2011, by the same inventor and entitled “Methods And Systems For Internet-Based Network Shareholder Communication, Voting, And The Creation Of Regulatory Compliant Shareholder Proposals”, the disclosure of each of which is incorporated herein by reference as if set forth in full.

### TECHNICAL FIELD

This disclosure relates generally to business methods and technology to implement the methods and more particularly to a methods and systems for internet-based electronic communications between shareholders and corporate owners, together with server-hosted software applications to implement the methods.

### BACKGROUND

The present disclosure relates to a method and system for conducting and storing Internet based electronic shareholder communication utilizing an Internet accessible Network of known stakeholders and server hosted communication software applications. The term “Network” as used herein shall be used to refer the online community of members to distinguish the term from, for example, a telecommunications network.

Modern communication between public corporations and their shareholders or shareholder representatives occurs in several ways. Official press releases are issued that announce what are considered to be material events. Documents are filed with the SEC when certain other events take place such as insider purchases or sales. Quarterly and annual reports are produced and released that show financial details. Quarterly conference calls occur where shareholders have the chance to query officers during a defined time period. Finally, there is the annual shareholder's meeting where presentations and Q&A sessions occur.

It is also common for publicly held corporations to maintain an Investor Relations (“IR”) department where interested parties may correspond with the corporation. These departments field individual questions regarding corporate information. The inventor surmises that the correspondence of any one shareholder and the corporation may be relevant to all shareholders. The degree to which the corporation accommodates any one shareholder, no matter the size of holdings or influence of that particular shareholder, is of importance to all shareholders.

The interaction between an individual shareholder and the corporation may now occur over a telephone call or an email. The exchanged information is not currently captured or stored. This may cause IR departments to field the same question repeatedly. The IR department answering repetitive questions and different shareholders repeating the same question imparts a greater effort on the shareholder pool and IR departments as a whole.

On occasion, a corporation IR department may not adequately address the matter or shareholder. There is not much individual recourse available if the corporation ignores the query or fails to address the matter. In such cases a frustrated investor may simply endure the transgression or sell the stock out of frustration which fails to solve the problem of the underperforming IR department. If a corporation knows that a response to any one shareholder query would/could be viewed by all shareholders, they may realize the prudence of treating every inquiry very seriously. It would also allow every other shareholder who witnesses the transgression to immediately contact the concerned IR department and express their concern over the treatment of a fellow shareholder.

It is the inventor's proposal that a web based application, or applications, which centralizes and records shareholder communication with complete transparency and accessibility would increase the ability for shareholders to enact good corporate governorship.

### SUMMARY

The method and system herein provided enhances shareholder communication by allowing shareholder correspondence to be initiated, sent, and recorded in web-based forum where all shareholders can witness the transaction in real time. The system automatically identifies shareholders by searching a server database for previously entered data that matches the member to the stock in question. If the member is an owner, server hosted software will allow the member to access the corporate query application.

The member/owner then has the option to title (provide a subject line) and draft a written correspondence to the corporation. Once complete, the member may send the correspondence and the query process will be initiated.

As the initiation process is implemented, all registered Network member shareholders of the same corporation will be notified of the process initiation. This may occur, in specific embodiments, as an update to a personal profile page of those members owning the stock. It may also be delivered by email to the owner members of the concerned stock if they are subscribed to this option. The system automatically identifies fellow owners by conducting a Network owner search utilizing the stock ticker symbol and cross referencing other members previously input holdings data.

A time of initiation is established automatically and the elapsed time is recorded. The purpose of this record is to measure corporate response time. A time frame is predetermined to establish an “acceptable” response time. If the corporation responds and the querying member is satisfied, the option to close the query is presented. If the corporation responds but the member is not satisfied the member may re-query the corporation and start the process again. If the corporation does not respond and the time frame is exceeded, the correspondence is flagged as “insufficient response” and all shareholders will be notified via email if subscribed or via their individual profile pages.

Other shareholders who have witnessed the “insufficient response” will then be presented with the electronic option to respond to the corporation. An additional email response template is presented. The subject/title will automatically entered by the software since the response would be in relation to another shareholders initial query. The responding shareholder could then send their response to the corporation utilizing the same process.

The system software maintains a rolling 365-day calendar of the company's investor relations effectiveness, which will be calculated by (the total number of queries sent−the number of insufficient response reports) divided by (the total number of queries sent), all multiplied by 100. This number will fall between 0 and 100, and give shareholders a good indication of the company's IR department effectiveness. In the same manner as the reputation scores, a higher score will be colored a darker shade of green; a lower score will be colored a lighter shade of green. Scores below 70 will be marked red. Those between 70 and 80 will be colored yellow, and those above 80 will be colored from light green to dark green as the score approaches 100.

The server hosted memory store records all exchanged correspondence between members and corporations. The server will host a search engine capable of searching query histories using key words, dates, or “insufficient” outcomes.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a diagrammatic illustration of an exemplary embodiment of an internet browser portal user interface of the present disclosure depicting a company profile.

FIG. 2 is a diagrammatic illustration of an exemplary embodiment of a communications template of the present disclosure.

FIG. 3 is a diagrammatic illustration of an exemplary embodiment of a communications alert of the present disclosure.

FIG. 4 is a diagrammatic illustration of an exemplary embodiment of the company profile of FIG. 1 depicting an updated communications status.

FIG. 5 is a diagrammatic illustration of an exemplary embodiment of a communications thread of the present disclosure.

FIG. 6 is a diagrammatic illustration of an exemplary embodiment of a communications thread of the present disclosure showing a comment.

FIG. 7 is a diagrammatic illustration of an exemplary embodiment of a communications forum of the present disclosure.

FIG. 8 is a diagrammatic illustration of an exemplary embodiment of a company search function user interface of the present disclosure.

FIG. 9 is a diagrammatic illustration of an exemplary embodiment of a company search function user interface of FIG. 8, showing instant results.

FIG. 10 is a diagrammatic illustration of an exemplary embodiment of a member dashboard of the present disclosure.

FIG. 11 is a diagrammatic illustration of an exemplary embodiment of the internet browser company profile of FIG. 4, showing an “Insufficient Response” entry.

FIG. 12 is a diagrammatic illustration of an exemplary embodiment of the company profile of FIG. 1, with an updated score.

FIG. 13 is method flow chart illustrating an exemplary embodiment of a method of the present disclosure.

### DETAILED DESCRIPTION

The present disclosure provides a system that includes without limitation a website hosted on at least one server connected to the World Wide Web, sometimes also referred to herein as the Internet, and a Network of shareholder website members, wherein at least one server hosting the website comprises a processor and a computer readable memory unit coupled to the processor, said memory unit containing program code configured to be executed by the processor to implement the methods for shareholder communications herein described. It will be understood that when this disclosure refers to actions or input by a user of the system, such as by an initiating member or a recipient company, that the software applications are accepting and processing such user input. For the purposes of this disclosure the terms “company” and “corporation” are used interchangeably.

A method for initiating, sending, and recording shareholder written communication provides, in specific embodiments, an online community of Network members, an internet accessible database on one or more servers containing the applicable personal details regarding a plurality of Network members, a computer-based login process that matches a particular Network member to the database, a computer component having a memory store, said memory store containing first program code configured to identify owners and facilitate the communication between the owner (or owner representative) between one or more shareholders and the owner of a selected corporation. The method is initiated, for example, by any member who is verified as a shareholder using a second program code (i.e., software) application that allows members to assign a title (i.e., subject line), construct a written correspondence to the concerned corporation then email said correspondence to the corporation contact information previously entered into the server hosted database.

The internet accessible verification system automatically utilizes the name and password previously established to access the data base and utilizes the system software. The system confirms the user is a Network member. A software function verifies the Network member is an owner of the concerned corporation based on previously entered holdings information entered into the database. The time of data entrance is recorded by the database. The software identifies all Network owners of the concerned stock identified by the stock ticker symbol and previously input holding information input by the members themselves.

Network members have the option of initiating the inquiry, then entering the title (reason or subject line) for correspondence, entering the actual correspondence, as well as the option to attach documents or source links, and the option to send the drafted correspondence to the concerned corporation contact. The correspondence drafted may include, for example, personal details of the inquiring shareholder such as first name, last name, and title “shareholder.” The corporation will then have pertinent data to verify the inquirer is an actual shareholder. The application automatically retrieves this data from personal member information stored in the database.

The application database contains corporate contact information. This data is referenced by the application in determining the proper distribution of the electronic correspondence. The application identifies this proper contact information using the stock ticker symbol as an identifying data point. When the user selects the “submit” option the information is electronically sent.

Alternative embodiments of the method provide a third program code that facilitates an electronic notification system that notifies all other registered owners of said corporation, that a shareholder query has occurred, a fourth program code that enables a plurality of owner shareholders to view the written correspondence, a fifth program code that records the time the correspondence is sent, displays a running clock that measures the corporate response time, a memory store that records the initial correspondence, recognizes and displays the corporate response, and then establishes a record.

A notification function sends electronic notification to all owners of the stock. These members were previously identified and the referenced holdings data is located in the database. This notification may also be sent to members who have chosen to receive notifications regarding this stock.

Specific embodiments provide an application that identifies as a corporate response any email response received from the same email address domain to which the query email was sent. Any emails received in response from a different email domain will be automatically forwarded to administrators for review and will not trigger the response software. As such, the provided response is not viewable or recorded as a response from the corporation.

After receiving an identified corporate response, all shareholders Network members are automatically notified who are identified by the software as owners, or those who have chosen to receive notifications by update on their individual Network profile page or by email if the said member is subscribed to this process. All fellow Network members may view the response. After receiving an identified corporate response, the system presents the initiator with the option to close the query if the member is satisfied with the corporate response.

After receiving an identified corporate response, if the initiator is not satisfied with the corporate response the initiator may re-query the corporation and the entire method and time frames start again.

Other alternative embodiments provide, in addition to the foregoing, a sixth program code that establishes a predetermined time frame after which exceeded, alerts all shareholders of the concerned corporations failure to respond to the inquiry, a seventh program code that allows other shareholders to query to concerned corporation regarding the matter, and an eighth program code that provides a search method to electronically access previous exchanges and details.

A software application, or suite of applications, hosted on the database server records the point at which the email is sent, establishes a predetermined time frame that after which is exceeded without a corporate response, notifies all shareholders of the corporations failure to respond and presents an individual query option for every owner to respond to the matter. The software automatically identifies the expiration of the established time frame and updates the profile pages of all fellow owners or provides notification by email if fellow owners are subscribed to this function.

A notification function that, after the established time frame is exceeded, automatically notifies all shareholders and those who have chosen to be notified that an “insufficient response” has occurred, where an “insufficient response” report is defined as a failure to respond in the required time frame. After the failure to respond is identified, all fellow shareholder members are presented with the option to individually query the corporation. The query template is presented with the title automatically filled in utilizing the subject matter identified by the original shareholder who first queried the corporation.

A memory store, catalog process, and search application stores, organizes, and allows the retrieval of archived shareholder correspondence data. A ninth program code provides a function for recording and measuring the communication performance record of a concerned corporation which provides a metric and process used as an indicator of corporate communication performance.

The system memory stores correspondences referenced by the stock ticker symbol of the corporation(s) involved. A member may initially narrow their search to one corporation by entering the ticker symbol into the search function process on the Network. The search function allows any Network member the ability to search archived correspondence date utilizing key works in the title, a chronological order reference by the date of query, or separately search only “insufficient response” outcomes.

The software automatically tracks the amount of inquiries, the amount of recognized responses and assigns a number score to communications. The score is determined by dividing questions answered by questions asked then multiplying by a 100, and displaying within two decimal points. This numeric score is titled a “communication performance score” (CPS). A letter code is assigned to a corporation based on its communication performance score, (CPS). This process utilized the common grade system prevalent in American School Systems. For example, 90-100 is a “A”, 80-89 is a “B” and so forth. This would be displayed as “CPS 93.25 A”.

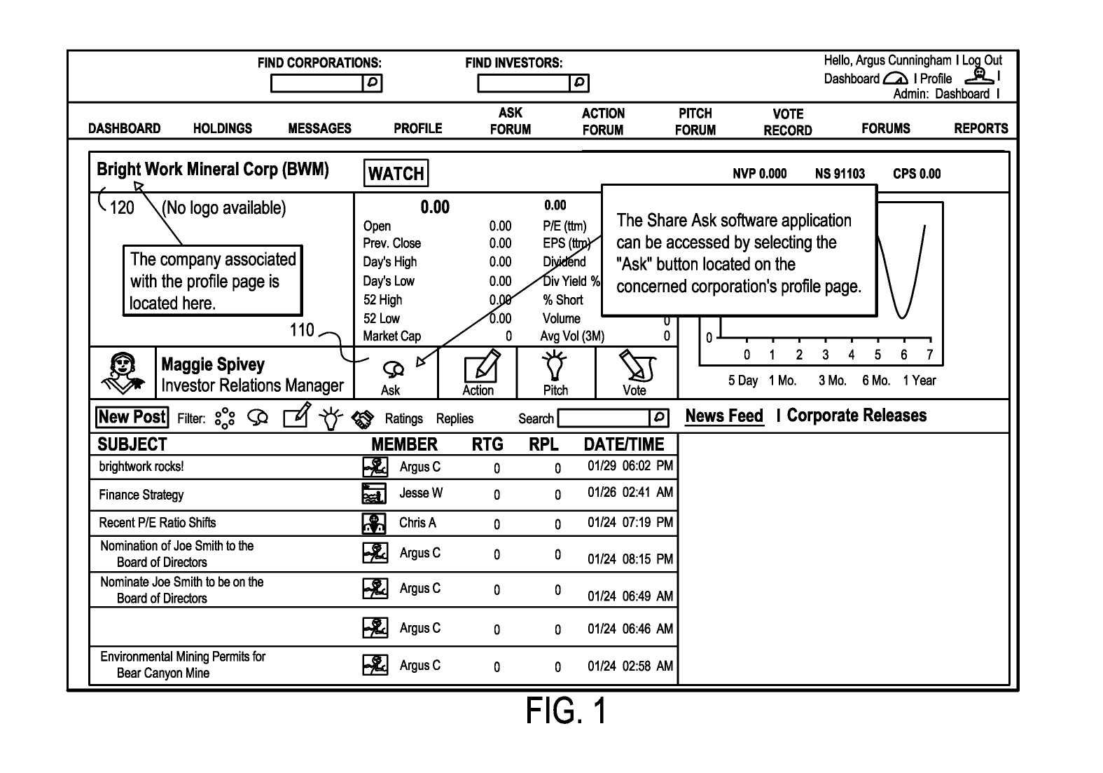

Referring now to the drawings, FIG. 1 is a diagrammatic illustration of an exemplary embodiment of an internet browser portal user interface of the present disclosure depicting a company profile. A fictitious company, Bright Mineral Works (“BWM”) 120, is presented for illustrative purposes. The user interface provides a virtual button 110 that launches the communications protocol software of the present disclosure.

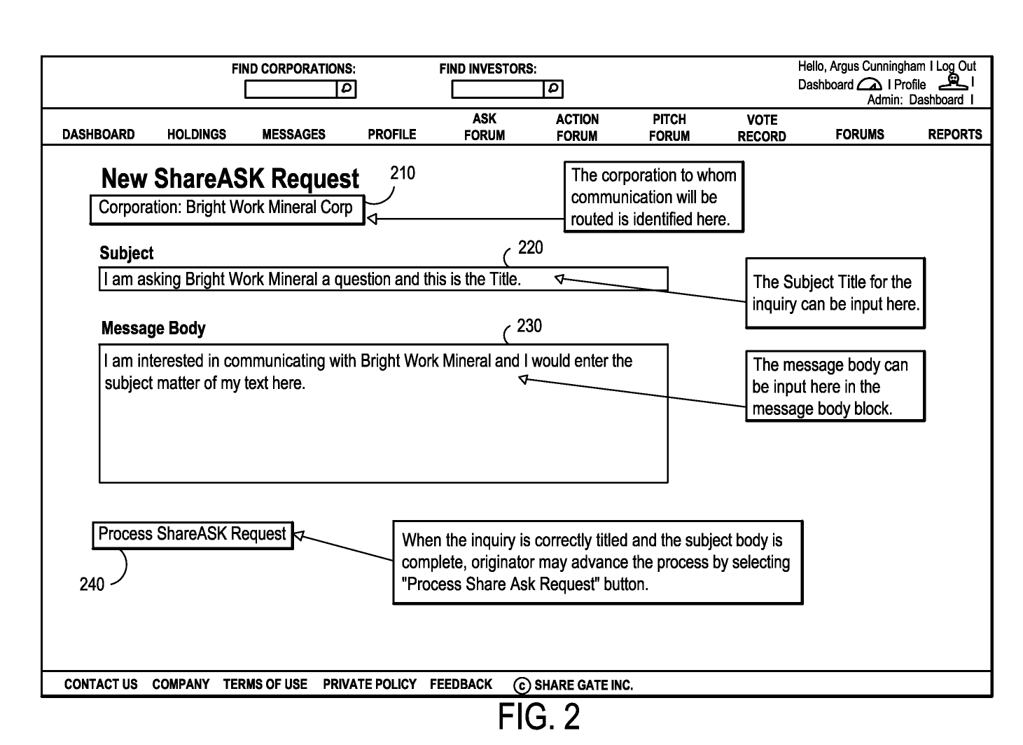

FIG. 2 is a diagrammatic illustration of an exemplary embodiment of a communications template of the present disclosure. Launching the communications protocol software generates an email template directed to BWM 210. Subject line 220 provide a text box where a user can enter a title or otherwise identify the topic of the communication. Message box 230 provides a text box familiar to anyone who uses email wherein the user may enter the body of a communications. Virtual button 240 is a “send” function that electronically transmits the communication to BWM.

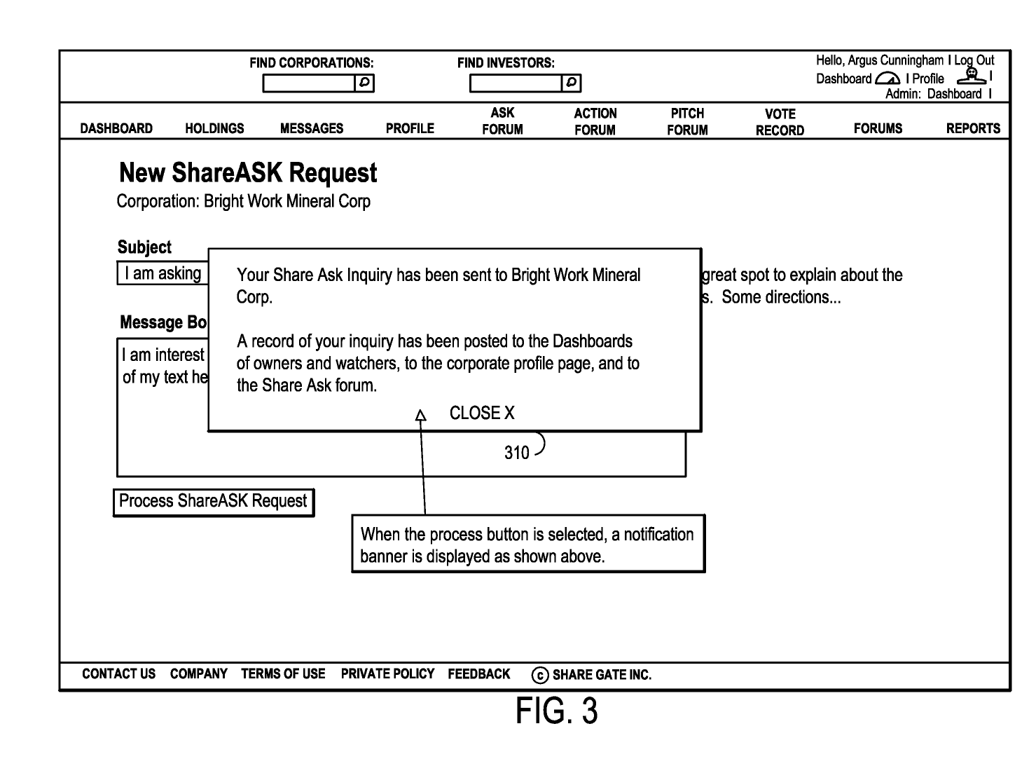

FIG. 3 is a diagrammatic illustration of an exemplary embodiment of a communications alert of the present disclosure. Alert or status indicator 310 confirms that the communication of FIG. 2 was successfully sent. Alert 310 may take the form, for example, of an interstitial web page that may be manually closed by the user. In specific embodiments, thee alert goes away automatically after a predetermined time of display.

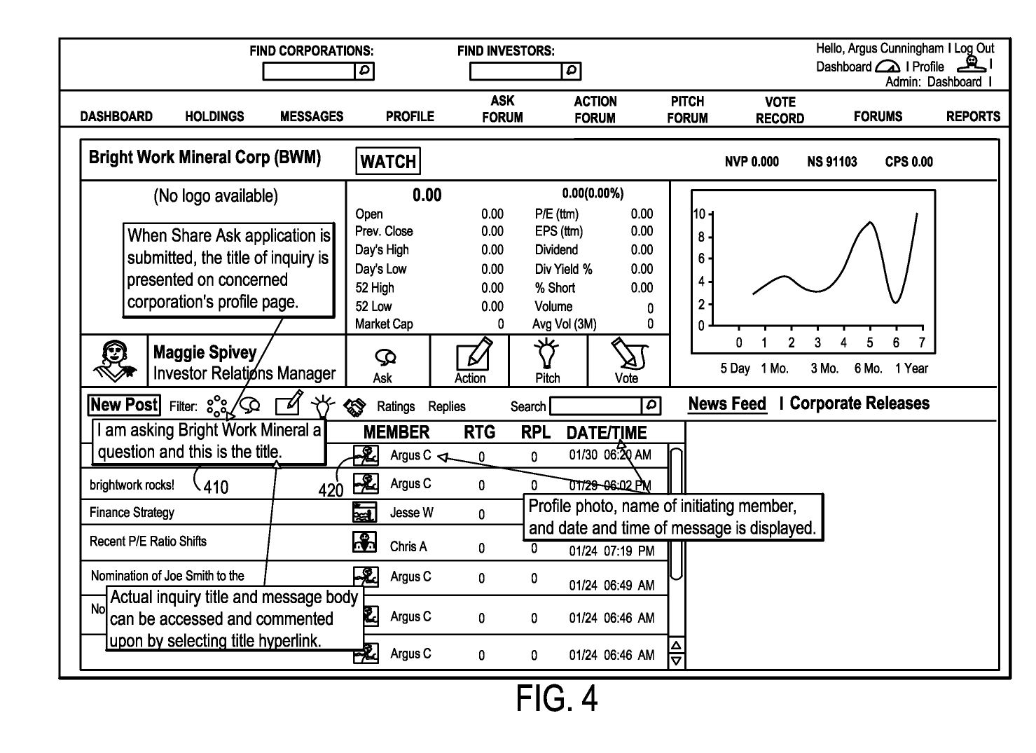

FIG. 4 is a diagrammatic illustration of an exemplary embodiment of the company profile of FIG. 1 depicting an updated communications status. The title of the communication from FIGS. 2 and 3 is displayed 410 on the BWM company profile page. The message body may be selectively accessed by Network members via display 410. The identity of the initiating shareholder 420 id also displayed in specific preferred embodiments.

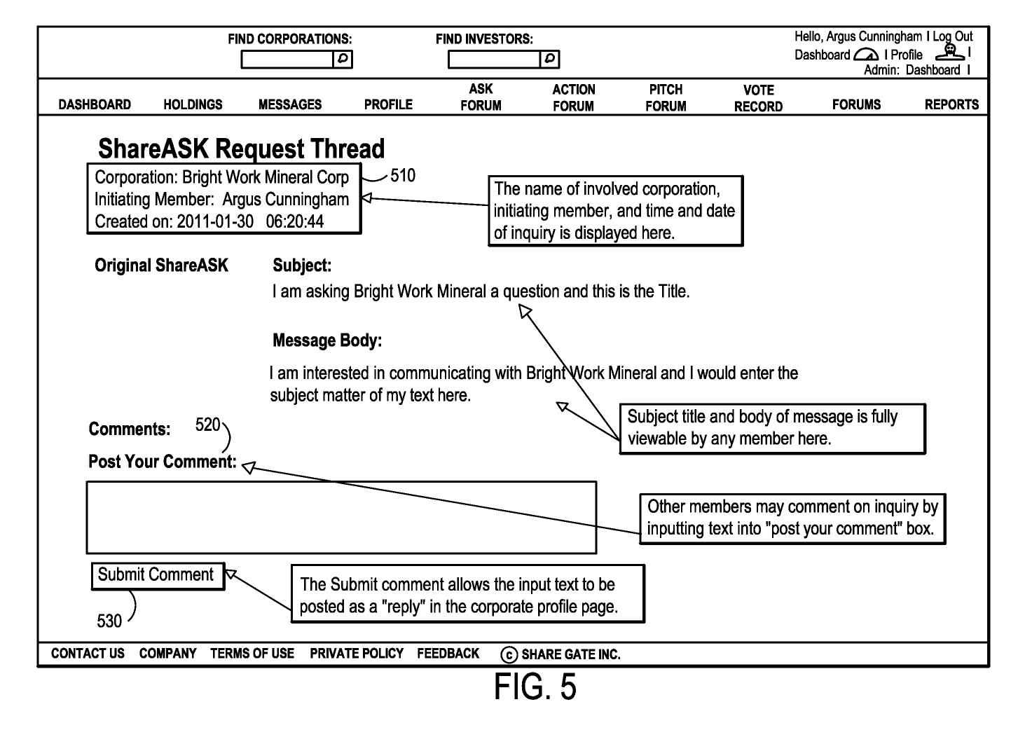

FIG. 5 is a diagrammatic illustration of an exemplary embodiment of a communications thread of the present disclosure. Accessing the message from display 410 opens request thread 510 for BWM which shows the title and body of the message and which also provides an online comment thread 520 where Network members can post 530 comments or questions regarding the message.

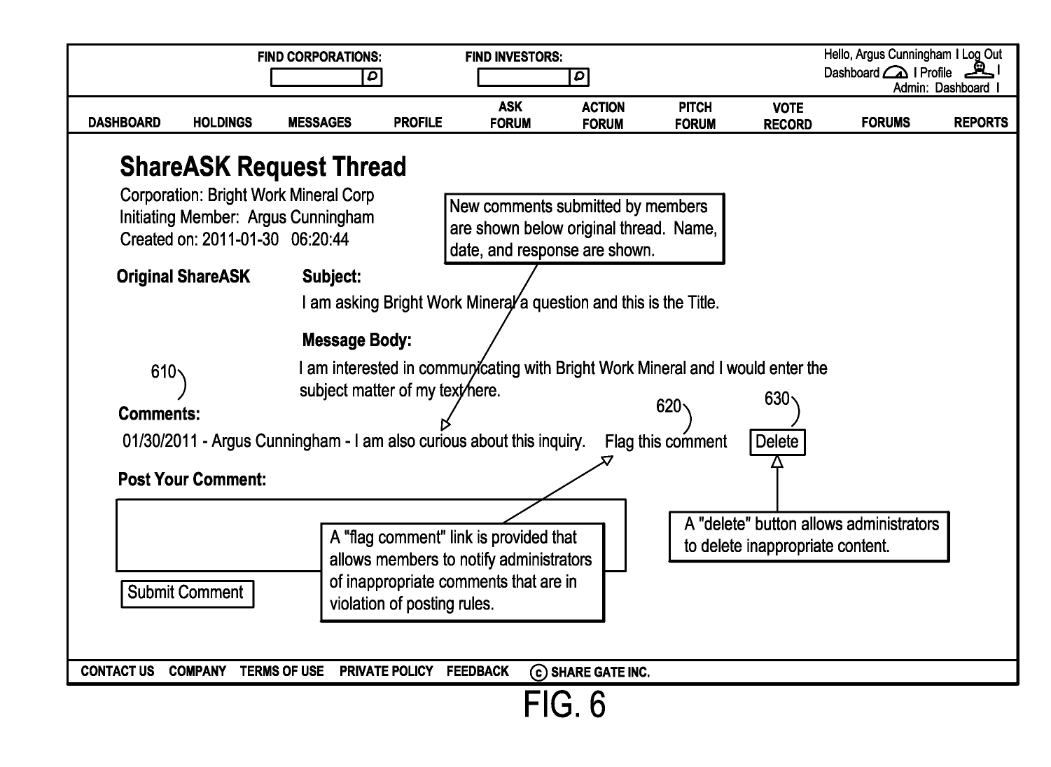

FIG. 6 is a diagrammatic illustration of an exemplary embodiment of a communications thread of the present disclosure showing a member comment. Comments 610 may be flagged 620 for inappropriateness or for other reasons specified in the Network membership terms and conditions, for example, or other applicable rules. A delete function 630 is also provided. In specific preferred embodiments, only the member who posted the comment, or an authorized system administrator, is authorized to delete a comment. Comments scroll in chronological order as those familiar with web site forums and comment sections will recognize.

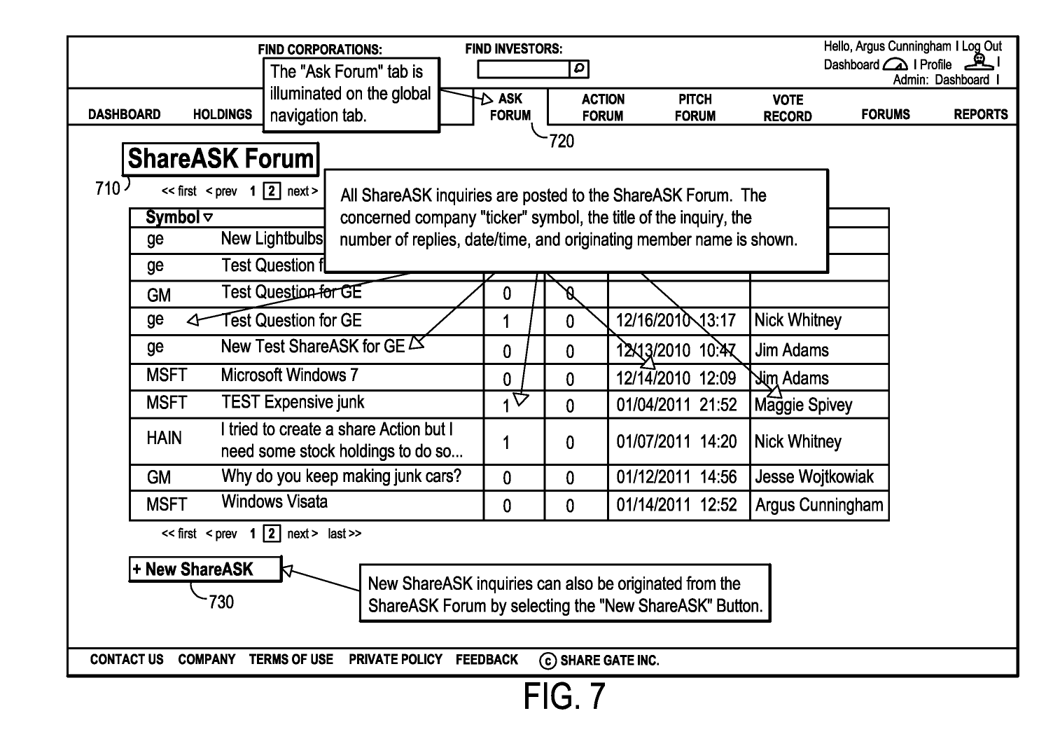

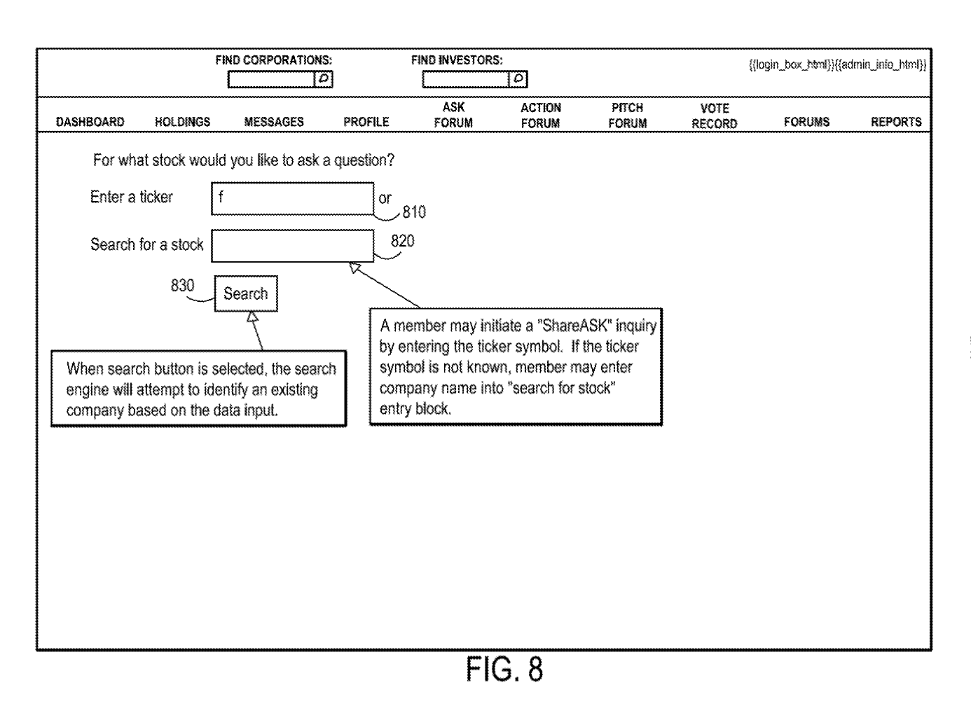

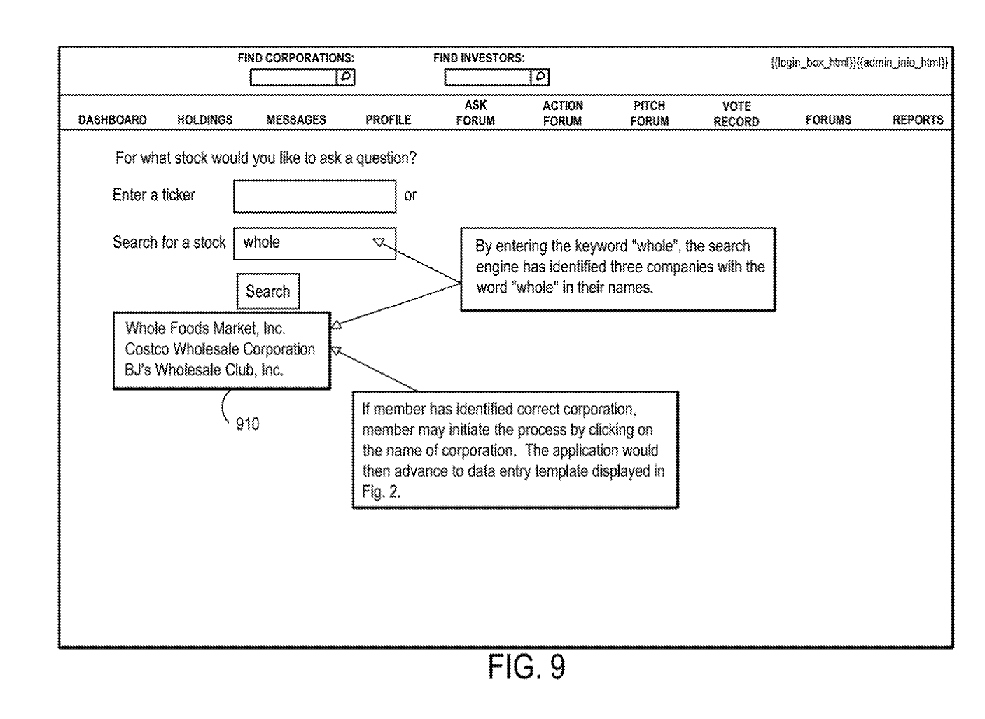

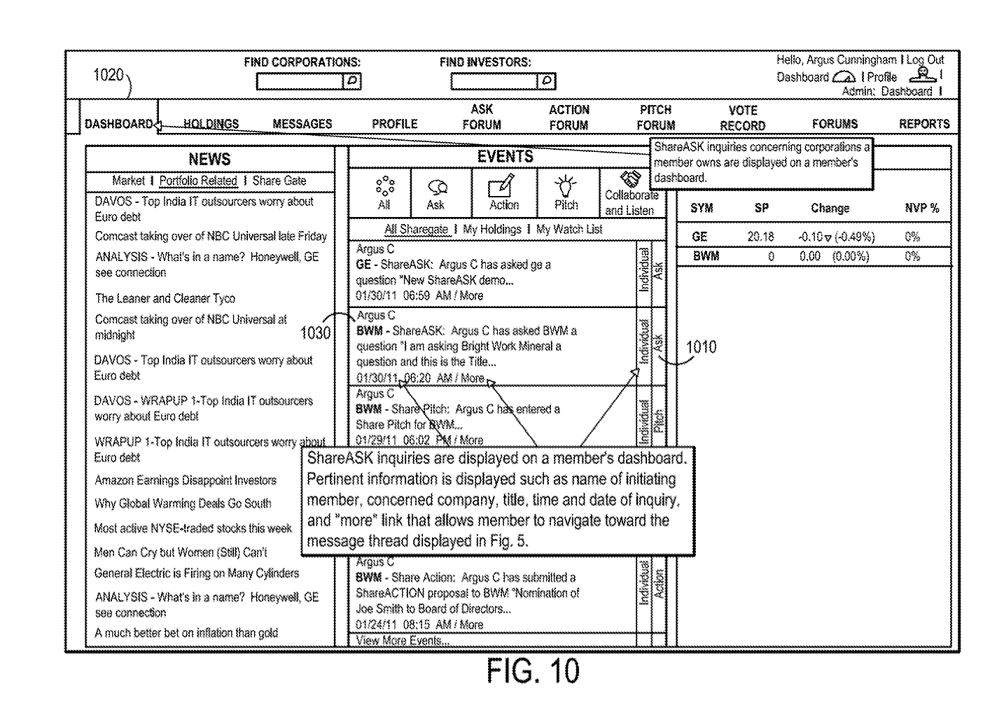

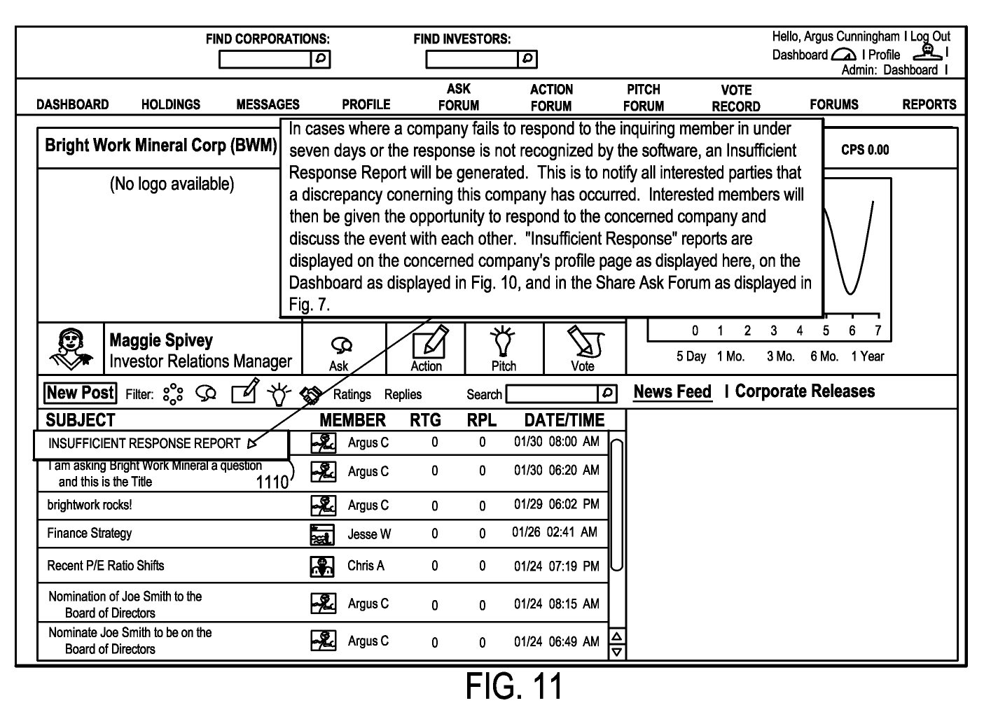

FIG. 7 is a diagrammatic illustration of an exemplary embodiment of a communications forum of the present disclosure. All communications threads of the present disclosure are displayed in forum 710 which is accessed by members via the forum tab 720 in the navigation bar of the user interface. Communication threads for companies in which one or more members own stock are displayed by company ticker symbol down the left side of the forum. A new message process may be initiated from the forum by launching the software application with virtual button 730.

FIG. 8 is a diagrammatic illustration of an exemplary embodiment of a company search function user interface of the present disclosure. A system of the present disclosure provides a company search function whereby a user/member may search for a company in order to initiate communications with a desired company. Searches may be performed on the basis of the company ticker symbol 810 or company name 820.

FIG. 9 is a diagrammatic illustration of an exemplary embodiment of a company search function user interface of FIG. 8, showing instant results. As a user begins to type or enter the name of a company, for example, results are instantly displayed in a drop down window 910.

FIG. 10 is a diagrammatic illustration of an exemplary embodiment of a member dashboard of the present disclosure. The member dashboard 1020 provides an Events section which displays, among other things, the company communication 1010 initiated by the member 1030. Data such as the company identity, the date of the communication, the title or subject of the communication and so forth. Entry 1010 contains an active link to thread 510 so that members may follow and respond to comments concerning the communication.

FIG. 11 is a diagrammatic illustration of an exemplary embodiment of the internet browser company profile of FIG. 4, showing an “Insufficient Response” entry. A response may be deemed insufficient, for example, because the company did not respond before a preset deadline (7 days, for instance) or because the response was not recognized by the system software. The insufficient response notice is generated automatically pursuant to predetermined response parameters.

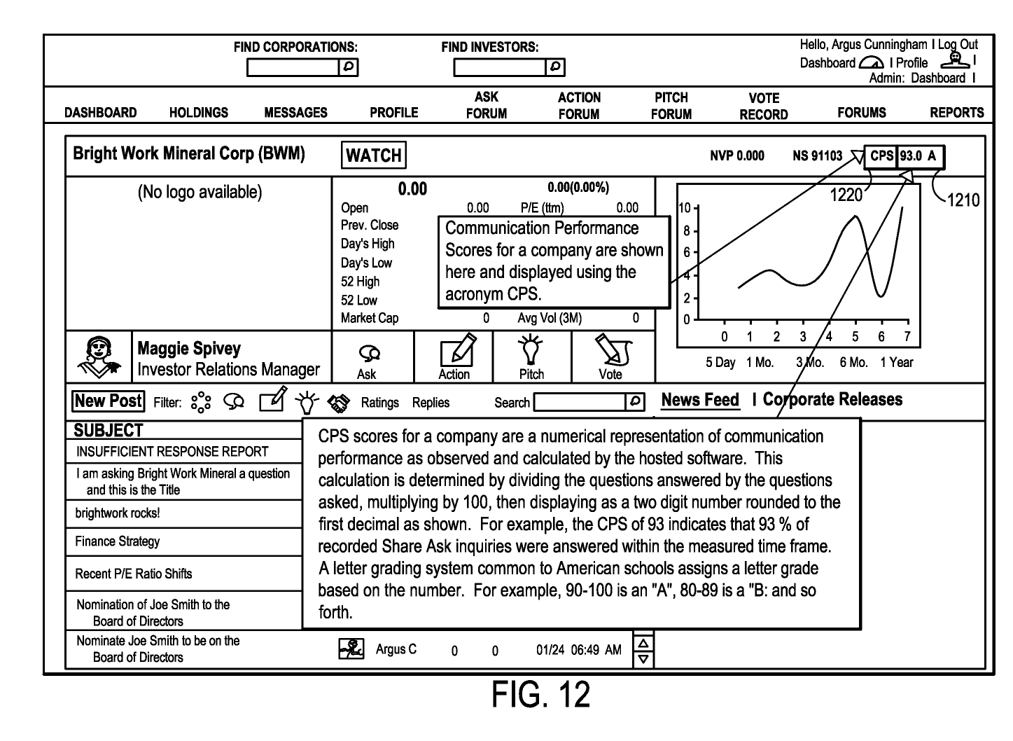

FIG. 12 is a diagrammatic illustration of an exemplary embodiment of the company profile of FIG. 1, with an updated score. An advantageous feature of the present system is the automatic calculation of a Communication Performance Score (“CPS”) 1210 which is displayed 1220 on the company profile page. The CPS is a measure of satisfactory responsiveness of a company to member communications. In preferred embodiments, the CPS has a numeric component corresponding to the percentage of timely responses by the company, and an alphabetic component, which corresponds to a letter grade.

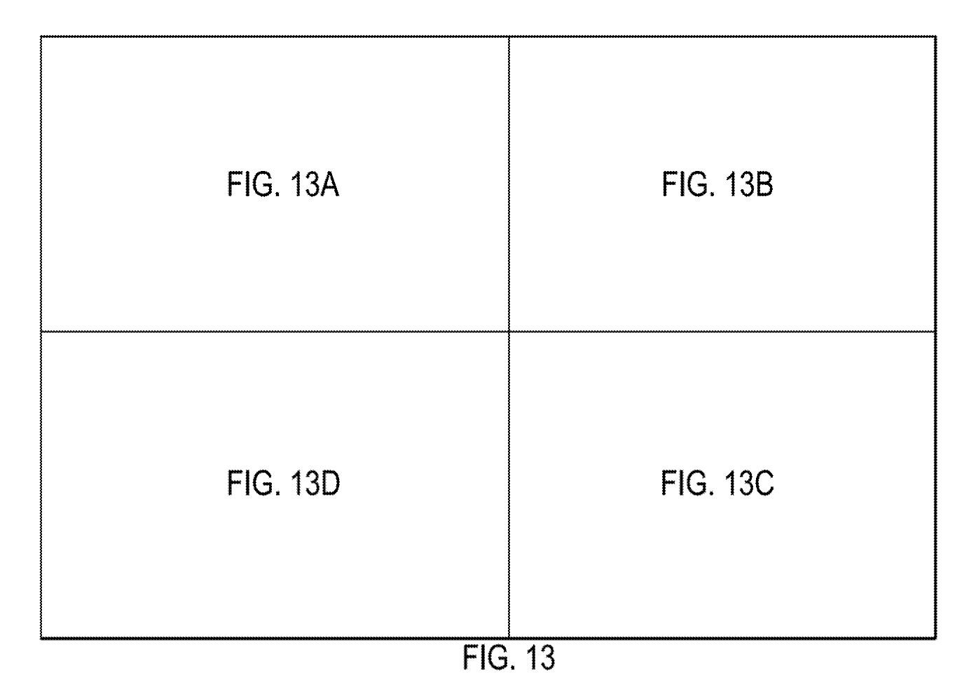

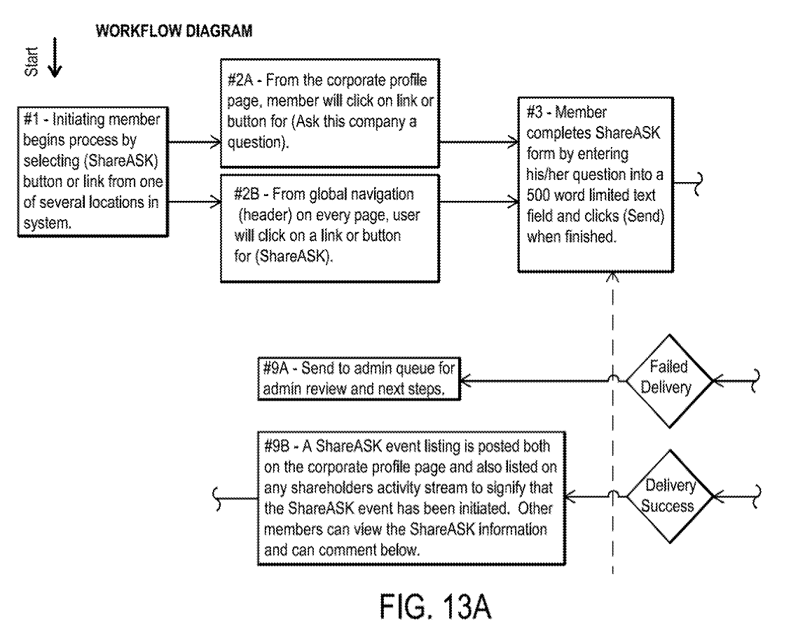

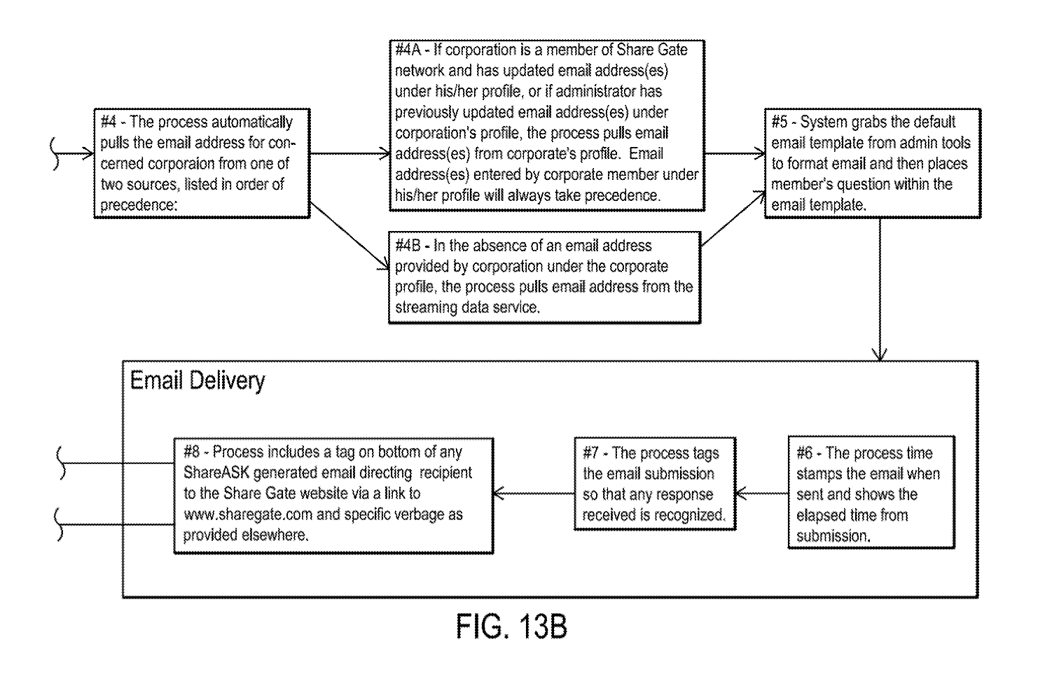

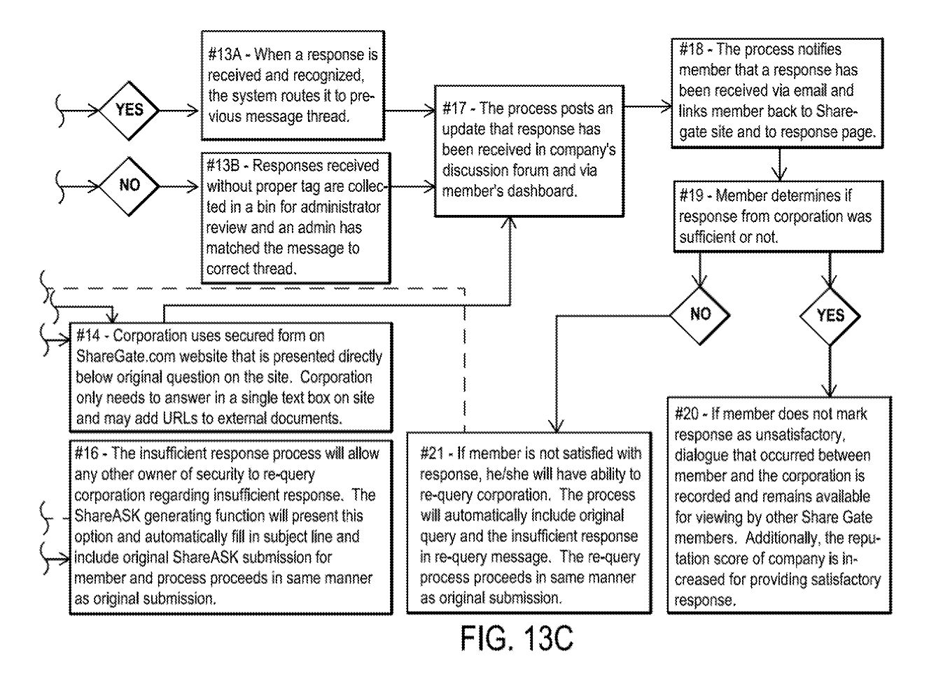

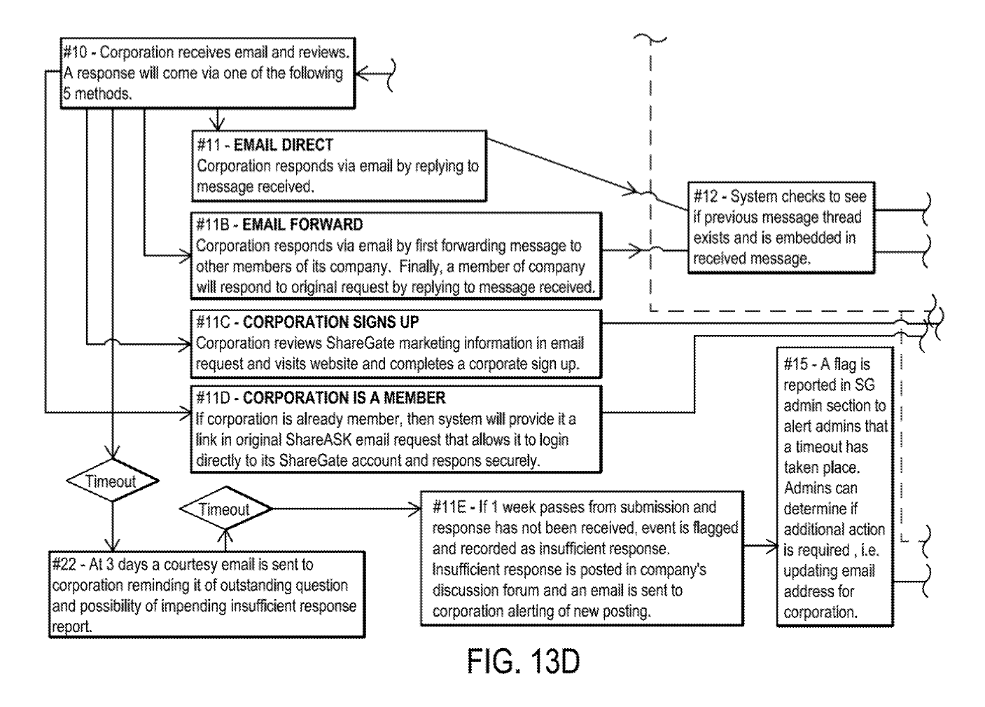

FIG. 13 is method flow chart illustrating an exemplary embodiment of a method of the present disclosure. From the upper right hand corner of the chart, the method is initiated (1) when a member activates the program launch virtual button from the user interface provided by the Network website. A launch button may be located at a company profile page (2A) or from a navigation bar (2B) on the user interface, or at one or more other suitable locations in the website.

Launching the software application generates a communication form that is completed by the initiating member as described above (3). Specific embodiments provide a form with preset limits on the number of characters permitted in the form. The company email address is obtained automatically by the software (4) either from the Network membership (4A) or from an external data provider (4B).

The communication is automatically formatted for transmission (5), time stamped (6) tagged to start a clock running to determine whether the company responds within a preset time limit (7), and provided with standard information about the system and Network (8). Failed delivery (9A) causes the software to send the message to admin for analysis. Successful delivery causes the software to update the company profile and the Event streams of relevant members for viewing by said members as well as the general membership of the Network (9B).

The company receives the message (10) and responds pursuant to options provided by the system: by direct email to the initiating member (11A); by forwarding the message within the company to a company employee appropriate for responding to the message (11B); by signing up via the Network website to join the Network (11C); if the company is an existing Network member, by replying directly within the Network (11D). However, if the company fails to respond via any of the aforementioned avenues within the preset time limit, the system times out and the message is flagged and having received an insufficient response (11E). If an insufficient response is flagged (per 11E), a notice of insufficiency is automatically posted the corporation's discussion forum on the Network website and an email is automatically sent to the corporation to notify it of the notice. The Network website admin office is notified of the insufficiency flag to determine whether further action by the Network is recommended (15). Any other Network member who is a shareholder of the corporation may query the corporation about the insufficiency (16).

In the cases where the company responds by direct email (11A) or forwarding internal for reply (11B), the system automatically checks to see if there is an existing email thread embedded in the reply (12). If a thread exists the message is appended to the thread, i.e., routes the reply to the existing thread (13A). A reply without a readable tag is routed to admin for analysis (13B).

In the case where the corporation is already a Network member or has signed up as a member, the corporation accesses the Network website and responds the shareholder inquiry directly in the message thread, similar to posting a comment to a social network website (14). The initiating member is automatically notified via the member's website dashboard about the corporation's response (17) and is also notified automatically by email (18). The member proceeds with the present method (19), depending on whether or not the corporation's response is sufficient.

If the corporation's response is not unsatisfactory, then the dialog between the initiating member and the corporation is automatically recorded and is viewable by other Network members. Additionally, the corporation's improved CPS score is recalculated and posted automatically (20). If the corporation's response is deemed unsatisfactory, the initiating member may re-query the corporation (21). The re-query automatically includes the previous communication thread. The re-query process proceeds through the same method as with a new query described herein.

An insufficient response may be the result of an untimely reply by the corporation. That is, the corporation fails to reply within a predetermine amount of time, such as one week or 10 days from the date of the original query. Specific embodiments provide that the corporation is automatically reminded by email at a predetermined intermediate time (such as 3 days) that a response is due to avoid an insufficiency notice (22).

The system software maintains a rolling 365-day calendar of the company's investor relations effectiveness, which will be calculated by (the total number of queries sent−the number of insufficient response reports) divided by (the total number of queries sent), all multiplied by 100. This number will fall between 0 and 100, and give shareholders a good indication of the company's IR department effectiveness. In the same manner as the reputation scores, a higher score will be colored a darker shade of green; a lower score will be colored a lighter shade of green. Scores below 70 will be marked red. Those between 70 and 80 will be colored yellow, and those above 80 will be colored from light green to dark green as the score approaches 100.

In addition to the foregoing embodiments, the present disclosure provides a system that includes without limitation a website hosted on at least one server connected to the World Wide Web and a Network of shareholder website members, wherein at least one server hosting the website comprises a processor and a computer readable memory unit coupled to the processor, said memory unit containing program code configured to be executed by the processor to implement a method for conducting a shareholder action among shareholders of a company in an online Network.

In specific embodiments, the methods of the present disclosure are executed at least in part with the use of programs stored on machine readable medium to operate computers and devices according to the principles of the present disclosure. Machine readable media include, but are not limited to, magnetic storage medium (e.g., hard disk drives, floppy disks, tape, etc.), optical storage (CD-ROMs, optical disks, etc.), and volatile and non-volatile memory devices (e.g., EEPROMs, ROMs, PROMs, RAMs, DRAMs, SRAMs, firmware, programmable logic, etc.), server hard drives, thumb drives, also called memory sticks and the like. Furthermore, machine readable media include transmission media (network transmission line, wireless transmission media, signals propagating through space, radio waves, infrared signals, etc.) and server memories. Moreover, machine readable media includes many other types of memory too numerous for practical listing herein, existing and future types of media incorporating similar functionally as incorporate in the foregoing exemplary types of machine readable media, and any combinations thereof. The programs and applications stored on the machine readable media in turn include one or more machine executable instructions which are read by the various devices and executed. Each of these instructions causes the executing device to perform the functions coded or otherwise documented in it. Of course, the programs can take many different forms such as applications, operating systems, Perl scripts, JAVA applets, C programs, compilable (or compiled) programs, interpretable (or interpreted) programs, natural language programs, assembly language programs, higher order programs, embedded programs, and many other existing and future forms which provide similar functionality as the foregoing examples, and any combinations thereof.

Additionally, the present disclosure contemplates the present methods, system and software applications adapted for mobile devices such as smart phones and tablet computers that utilize software “apps” in which, for example, the user interface and displays of the present system are configured for portable devices with relatively small screens.

Many modifications and other embodiments of the methods and systems described herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for information sharing between a corporation and one or more shareholder of the corporation via a website hosted on at least one server connected to the Internet, wherein at least one server hosting the website comprises a processor and a computer readable memory unit coupled to the processor, said memory unit containing program code configured to be executed by the processor to at least partially automate one or more of the steps of the method, the method comprising:
launching communication software from the website;
transmitting communication electronically to a recipient corporation via the communication software;
automatically displaying the transmitted communication on the website;
displaying any response from the corporation on the website; and
automatically scoring the response from the corporation.

2. The method of claim 1, further comprising providing a Network of shareholder website members.

3. The method of claim 1, further comprising determining whether or not a corporation response is sufficient or insufficient.

4. The method of claim 3, further comprising transmitting a re-query to the corporation in the case where the response is determined to be insufficient.

5. The method of claim 1, further comprising setting a predetermined amount of time for the corporation to respond.

6. The method of claim 5, further comprising automatically reminding the corporation that a response is due.

7. The method of claim 1, wherein the corporation responds directly on the website.

8. A system for information sharing between a corporation and one or more shareholder of the corporation, the system comprising:
a website hosted on at least one server connected to the Internet, wherein at least one server hosting the website comprises a processor and a computer readable memory unit coupled to the processor, said memory unit containing program code configured to be executed by the processor to at least partially automate one or more of the steps of a method, the method comprising launching communication software from the website; transmitting communication electronically to a recipient corporation via the communication software; automatically displaying the transmitted communication on the website; displaying any response from the corporation on the website; and automatically scoring the response from the corporation.

9. The system of claim 8, further comprising a Network of shareholder website members.

10. The system of claim 8, wherein the website further comprises a user interface.

11. The system of claim 10, wherein the user interface further comprises a global navigation bar.

12. The system of claim 11, wherein the global navigation bar further comprises a communications tab.

13. The system of claim 10, wherein the user interface further comprises a virtual button to launch the communications software.

14. The system of claim 9, wherein the corporation is a Network member.
